(19) United States
(12) Patent Application Publication
(10) Pub. No.: US 2026/0264020 A1
(43) Pub. Date: Sep. 10, 2026

(54) DEVICE AND METHOD FOR PURIFYING A FLUID IN THE LIQUID PHASE

(71) Applicant: SOCIÉTÉ TECHNOLOGIQUE D’ECHANGEURS MEMBRANAIRES, PARIS (FR)

(72) Inventors: Assaad ZOUGHAIB, RAMBOUILLET (FR); Rolando ARGANDONA, PARIS (FR); David POIZAT, ANTONY (FR); Frederic WALLAND, GOUVIEUX (FR); Rasha MUSTAPHA, CACHAN (FR)

(21) Appl. No.: 19/167,959

(22) PCT Filed: Mar. 19, 2024
(86) PCT No.: PCT/EP2024/057268

§ 371 Date: Sep. 23, 2025

(30) Foreign Application Priority Data
Mar. 24, 2023 (FR) FR2302821

(51) Int. Cl. B01D 61/36; C02F 1/44; C02F 101/10; C02F 103/08

(52) U.S. Cl. CPC B01D 61/366; B01D 61/364; C02F 1/447; B01D 2311/2674; B01D 2313/22; C02F 2101/10; C02F 2103/08

(57) ABSTRACT

A device for purifying a fluid in the liquid phase, which device includes a nozzle for dispensing the fluid in the form of droplets in an atmosphere; a wall of a condenser; and a membrane permeable to the fluid in the gas phase and impermeable to the fluid dispensed in the form of droplets in the atmosphere, the membrane being arranged between the nozzle and the wall of the condenser; wherein the wall of the condenser and the membrane define a first space, and wherein the condenser includes a refrigerant flow circuit, the wall of the condenser separating the refrigerant flow circuit from the first space, the wall of the condenser being impermeable to the fluid in the liquid phase and in the gas phase and being configured to condense the fluid in the gas phase that has passed through the membrane into a purified fluid liquid phase.

### TECHNICAL FIELD OF THE INVENTION

The technical field of the invention is that of purifying a liquid.

In particular, the invention relates to the production and collection of purified fluid in the liquid state from a same non-purified fluid (e.g. containing a solute) by thermal distillation. For example, the invention relates to the production and collection of purified water from water containing a solute (e.g. salt water or mineral-laden water or polluted water).

### TECHNOLOGICAL BACKGROUND OF THE INVENTION

There are so-called “semi-permeable” membranes, defined as porous membranes that are permeable to gases and impermeable to liquids. These membranes are used between two media having different temperatures, the medium with the higher temperature being designated as the “hot medium” and the medium with the lower temperature being designated as the “cold medium”, conventionally.

The temperature difference between the hot medium and the cold medium induces a vapour pressure difference between these two media, resulting in an exchange between the two media, which takes place through or perpendicularly to a semi-permeable membrane in the vapour phase, from the hot medium to the cold medium. After passing through a semi-permeable membrane, this vapour condenses in the cold medium, resulting in the dilution of the cold liquid medium by the condensate of this vapour, which has become liquid.

To use this property industrially, a flow of cold fluid is added to the cold medium and a flow of hot fluid is added to the hot medium, for producing, from a hot liquid with an initial concentration of a first solute, a cooled hot liquid that is more concentrated in the hot hydraulic circuit after passing through the hot medium delimited by the membrane, and a cold liquid heated and diluted. This structure constitutes a heat and purified fluid exchanger between the hot medium and the cold medium in question, known from prior art.

As is known, there are devices comprising a nozzle and a mechanically weak membrane, soaked in a gas, for dehumidifying or humidifying the gas, but they are unsuitable for use in a purified water generator.

In a known manner, it is also possible to use a first pressure reducer or hot pressure reducer, as for example a first nozzle or hot nozzle, in the hot hydraulic circuit, and a second pressure reducer or cold pressure reducer, as for example a second nozzle or cold nozzle, in the cold hydraulic circuit, to operate at the same pressure, for example at atmospheric pressure, on each side of the membrane in order to allow the use of any semi-permeable membrane, especially low-thickness membranes, which are easily produced in industrial amounts but are fragile and can only support a small pressure difference between the media they separate.

In practice, however, in nozzle devices, which operate by diluting the cold medium via the addition of liquid, especially water, vapour condensate production of purified liquid is only possible if purified liquid is circulated in the cold hydraulic circuit, which requires to have an initial volume of purified liquid available. These systems are therefore not adapted to the production of purified liquid, especially purified water, but only to the addition of purified liquid, especially purified water, in a hydraulic circuit that already contains it.

There is therefore a need to produce and collect purified liquid, for example purified water.

### SUMMARY OF THE INVENTION

The invention offers a solution to the problems discussed previously by providing a device for purifying fluids in a simple and effective manner, while consuming little energy.

One aspect of the invention thus relates to a device for purifying a fluid in the liquid phase. The device comprises:
a nozzle for distributing said fluid in the form of drops into an atmosphere;
a wall of a condenser; and
a membrane permeable to said fluid in the gas phase and impermeable to said fluid distributed in the form of drops in the atmosphere, the membrane being disposed between the nozzle and the wall of the condenser;
   wherein the wall of the condenser and the membrane delimit a first space, the membrane separates the first space from a second space comprising the nozzle, and wherein the condenser comprises a refrigerant fluid circulation circuit, the condenser wall separating the refrigerant fluid circulation circuit and said first space, the condenser wall being impermeable to the fluid in the liquid phase and in the gas phase and being configured to condense the fluid in the gas phase that passed through the membrane into a liquid phase of purified fluid.

By “nozzle”, it is meant an element able to divide a liquid into drops and expel the drops into the atmosphere (in other words, distributing the liquid in the form of drops into the atmosphere or a medium). By condenser, it is meant an apparatus able to condense (or liquefying) vapour. By “refrigerant fluid”, it is meant a fluid able to cool, typically having a temperature lower than the dew point of the vapour circulating in the space between the membrane and the condenser.

Such a device allows thermal distillation to be implemented, that is an evaporation-condensation cycle of a fluid containing a solute or a component that is non-volatile or less volatile than the fluid, with the concentration of the solute increasing in the part of the fluid that does not evaporate during the cycle and decreasing (or even being completely removed) in the part of the fluid that evaporates and then condenses. Thus, the term “purified fluid” or “pure fluid” designates the fluid obtained by evaporation-condensation during thermal distillation. The part of the fluid that does not evaporate is a fluid with a higher solute concentration, in other words, even less purified.

The fluid to be purified is called “non-purified fluid” or “non-pure fluid” and may be, for example, water containing minerals such as calcium, magnesium or salt (hereinafter referred to simply as “salts”), for example, water from a distribution system, seawater or polluted water.

By fluid, it is understood a fluid in the liquid phase (also simply called “liquid”) or in the gas phase (also referred to as “gas” or “vapour”).

When supplied with the non-purified fluid and refrigerant fluid, such a device advantageously makes it possible to purify the non-purified fluid and recover purified fluid from the non-purified fluid in a simple and effective manner.

Indeed, drops of non-purified liquid set to a first temperature (“hot” non-purified fluid, in the sense of “hotter than the wall of the condenser ”) can be distributed via the nozzle into an atmosphere between a pressurised inlet and an atmospheric pressure outlet of the nozzle, thereby causing vapour to form in the atmosphere in addition to the drops. The vapour corresponds to a gas phase of the purified fluid. Part of the vapour naturally migrates to the condenser (or cold trap), which is set to a second temperature lower than the first temperature, to be condensed at atmospheric pressure into purified liquid drops on a cold impermeable wall of the condenser.

Indeed, when a temperature difference is created between a hot liquid (whether a mixture of components or not) and a liquid or surface that is colder than this liquid and colder than the dew point of the atmosphere in proximity to the colder surface or the colder liquid, a difference in partial vapour pressure appears, driving a process of evaporation and condensation. Thus, vapour from the liquid formed on the surface of the hot liquid migrates to the liquid or surface that is colder than its condensation temperature and condenses. This phenomenon cools the hot liquid because the heat required for evaporation is removed therefrom and provides heat to the cold liquid or cold wall because heat released by condensation is transferred thereto.

Practical implementation of this physical principle faces several technical and functional difficulties. The risk of hot liquid being projected onto the cold liquid or surface and mixing with the condensate is a known risk of contamination or loss of condensate purity.

In the above device, the semi-permeable membrane disposed between the nozzle and the condenser wall makes it possible to separate the purified fluid vapour from the non-purified fluid drops, so that only a purified part of the fluid distributed in the form of drops reaches the space delimited between the condenser wall and the membrane, so that the purified part of the fluid is not “contaminated” with the non-purified fluid flowing on the other side of the membrane (on the side where the nozzle is). This membrane operates at equal pressure (e.g., atmospheric pressure) on both faces and is therefore subject to little mechanical stress. As a result, it does not require any special mechanical properties, which reduces the production cost thereof.

It is thus understood that the phrase “impermeable to fluid distributed in the form of drops” corresponds, in the context of the invention, to a property of the membrane for which liquid drops do not pass through the membrane when the device is in operation (and especially when fluid is distributed in the form of drops by the nozzle). For example, a membrane that is non-absorbent to liquid drops, a membrane made of a water-repellent material or coated with a water-repellent material, which does not allow liquid drops to pass therethrough, falls within the scope of the present invention. In particular, it is to be noted that the membrane is not necessarily impermeable to liquid: for example, if it is subjected to significant liquid pressure (example, a jet of liquid being directed against the membrane), it may become permeable and allow liquid to pass therethrough. On the other hand, it is important that the membrane be impermeable to liquid drops, so that only pure liquid vapour passes into the space between the condenser and the membrane, and no non-purified liquid passes into this space.

Of course, the device may comprise a plurality of the above elements, as described with reference to FIG. 1. It is thus possible to increase the exchange surface area in a modular manner by adding as many channels and nozzles as are necessary to perform heat and mass exchanges.

Hereinafter, the first space and the second space may also be referred to as “channels” or “fluidic channels”. The term “channel” or “fluidic channel” refers to an element or set of elements able to allow circulation of a fluid in the gas phase or the flow or circulation of a fluid in the liquid phase. A fluidic channel is able to transport vapour from a fluid in the gas phase and/or collect drops of liquid by dripping along said channel. A fluidic channel may, especially, be of a thickness less than or even much less than its length and width, when it is made by mounting two membranes or two walls similar to fabrics mounted to frames parallel to each other and spaced apart by the thickness of the channel, in the manner of the frames or shelves of a beehive, sealing being additionally achieved between the frames by means of elements connecting the frames to each other, according to the thickness of the channel.

For example, the nozzle may be a spray nozzle. In this embodiment, the fluid is projected by the spray nozzle in fine droplets, especially in a direction parallel to the membrane. The fine droplets promote evaporation of the liquid, while limiting pressure on the membrane.

For example, the nozzle may be a jet nozzle. In this embodiment, the fluid is projected by the spray nozzle in a jet, especially in a direction parallel to the membrane.

Other embodiments are possible. For example, the nozzle may be a hollow rod (or shank) (or pipe) with small holes pierced along its length through which the liquid is distributed in the form of drops.

In one or more embodiments, the membrane comprises a first face oriented to the first space and a second face oriented to the second space, and the membrane is configured to operate at equal pressure on its first face and on its second face.

For example, said pressure may be atmospheric pressure.

In one or more embodiments, the membrane and the condenser wall extend in substantially vertical planes.

According to these embodiments, the membrane and the condenser wall are planar (it is to be noted that undulations on the surface of the membrane are possible, as well as patterns on the condenser wall). By “substantially vertical”, it is understood that the membrane and the condenser wall may each form an angle with the ground between 70° and 110°.

Such a configuration advantageously maximises the heat exchange and condensation surface areas while minimising stresses on the membrane.

In these embodiments, if the nozzle is a rod with small holes pierced, the rod may extend substantially horizontally so as to distribute drops of fluid into the second space.

In one or more embodiments, the device further comprises a first fluid distributor to supply the nozzle with said fluid in the liquid phase and a second fluid distributor to supply the refrigerant fluid circulation circuit with the refrigerant fluid.

The first distributor (hereinafter referred to as the “hot liquid distributor” or “hot water distributor”) and the second distributor (hereinafter referred to as the “cold liquid/refrigerant distributor” or “cold water distributor”) make it possible to supply the device with the fluid distributed by the nozzle and the refrigerant fluid. As detailed later, these two distributors may be connected (possibly via other elements) so that the same fluid can be both the fluid distributed in the form of drops and the refrigerant fluid.

In one or more embodiments, the device comprises a collector configured to collect at least one part of the fluid distributed in the form of drops by the nozzle and circulating in the second space.

This collector, also referred to as a “hot liquid collector” or “hot water collector” hereinafter, advantageously allows recovery of the part of the fluid distributed in the form of drops by the nozzle that has not passed through the membrane in the form of vapour. This recovery can have several uses. For example, the fluid thus collected can be ejected from the device when it becomes too “impure” (example, too rich in salts). The collected fluid can also be reused as a refrigerant liquid after cooling, as detailed hereinafter. It is to be noted that the liquid collected by the hot liquid collector is less hot than the liquid at the nozzle outlet, as this liquid is cooled by evaporation as it passes through the second space.

In one or more embodiments, the refrigerant fluid circulation circuit, the nozzle and the second space belong to a same fluidic circuit.

By “fluidic circuit”, it is meant a fluid circulation circuit or, in other words, a circuit that allows fluid exchange between elements. Thus, according to these embodiments, there may be circulation of a same fluid in the refrigerant fluid circulation circuit and the second space. In other words, the fluid circulating in the second space can then circulate in the refrigerant fluid circulation circuit (possibly after passing through other elements of the device, such as a cooling system) and/or the fluid circulating in the refrigerant fluid circulation circuit can then be distributed into the second space through the nozzle.

In particular, the fluidic circuit may be a “closed fluidic circuit” (or “fluidically looped circuit”), i.e. a fluidic circuit wherein at least one part of the fluid at the outlet of the circuit is reinjected into an inlet of the circuit. It should be noted that the term “closed circuit” does not exclude the possibility that the circuit may comprise means for delivering and/or withdrawing fluid. In other words, part of the fluid circulating in the closed circuit may be withdrawn (for example liquid with a high salt content) and/or fluid from outside the circuit (for example liquid with a lower salt content) may be added to the closed circuit.

Other embodiments are possible. For example, the fluid circulating in the second space may be reinjected into the refrigerant circulation circuit, at the outlet of which it may be discharged. According to another example, the fluid circulating in the refrigerant fluid circulation circuit may then be distributed into the second space through the nozzle, and the remaining part of the liquid in the second space may then be discharged. These examples do not correspond to closed fluidic circuits, in that the circuit is not looped back on itself, but there is indeed a fluid exchange between the refrigerant fluid circulation circuit, the nozzle and the second space, which therefore belong to a same fluidic circuit for the purpose of the invention.

To implement such a fluidic circuit, the refrigerant fluid circulation circuit may comprise an inlet and an outlet, and the device may further comprise a first connection circuit between the outlet of the refrigerant fluid circulation circuit and the first fluid distributor.

By the term “connection circuit” between two entities, it is meant an element or set of elements that allows a fluid to circulate from one entity to the other. A connection circuit may comprise, for example, one or more ducts, as well as one or more intermediate systems, an intermediate system comprising, for example, an inlet through which the fluid can enter the system, a circulation circuit in which the fluid circulates and an outlet through which the fluid exits the system and an outlet in which the fluid can enter-such a system may be, for example, a fluid heating or cooling system.

Thus, according to one embodiment, the first connection circuit may comprise a heating system configured to heat a fluid circulating in said first connection circuit, a connection pipe connecting the outlet of the refrigerant fluid circulation circuit to said heating system, and a connection pipe connecting said heating system to the first fluid distributor.

Such a heating system advantageously allows a fluid exiting the circulation circuit of the condenser to be heated to a first temperature, and the fluid thus heated can supply the nozzle.

Further, the collector may be connected to the second fluid distributor.

Thus, the fluid collected in the collector can be reinjected into the second fluid distributor to be used as a refrigerant liquid in the circulation circuit of the condenser.

In this embodiment, the collector may be connected to the second fluid distributor by a second connection circuit, the second connection circuit comprising a cooling system configured to cool a fluid circulating in said second connection circuit, a connection pipe connecting the cooling system to the inlet of the refrigerant fluid circulation circuit, and a connection pipe connecting said cooling system to the collector.

Such a cooling system advantageously allows the part of the non-purified fluid distributed in the form of drops by the nozzle and which has not passed through the membrane in the form of vapour to be cooled for use as a refrigerant liquid.

As mentioned above, in some embodiments, the refrigerant fluid circulation circuit and the second space belong to a same closed fluidic circuit.

In one or more alternative embodiments, the refrigerant fluid circulation circuit and the second space belong to two independent fluidic circuits.

In other words, according to these embodiments, there is no fluid exchange between the second space and the refrigerant fluid circulation circuit. Thus, the fluid circulating in the condenser is not necessarily the same fluid as that distributed by the nozzle.

In one or more embodiments, the device may further comprise a gutter for collecting condensate formed on the wall of the condenser.

By the term “gutter”, it is understood any element for collecting condensate (herein, purified liquid) formed on the wall of the condenser. For example, the gutter may be a trough adjoined to the wall of the condenser (as in the example represented in FIG. 1) and having some slope to convey the condensate to a purified liquid collector. The gutter may also be one or more raised patterns on the wall of the condenser having the same function as in the preceding example.

The gutter on the one hand allows the condensate (the purified liquid) to be recovered and on the other hand avoids the condensate coming into contact with the collector, which contains the part of the fluid distributed by the nozzle that has not evaporated and has not passed through the membrane (and is therefore an even less pure fluid than that distributed by the nozzle). Thus, the gutter makes it possible to collect the condensate without it coming into contact with non-purified fluid and to convey it to a purified water circuit or tank.

Another aspect of the invention relates to a method for purifying a fluid in the liquid phase using a device described previously, comprising:
distributing the fluid in the form of drops through the nozzle, the fluid distributed in the form of drops being at a first temperature;
supplying the circulation circuit of the condenser with the refrigerant fluid at a second temperature, the second temperature being strictly lower than the first temperature; and
collecting purified fluid in the liquid phase derived from condensation of purified fluid in the gas phase along the wall of the condenser, said purified fluid in the gas phase being derived from passage of a gas part of the fluid distributed in the form of drops through the membrane.

In one or more embodiments, the fluid distributed in the form of drops is salt-laden water, and wherein the purified fluid in the liquid phase is pure water.

In one or more embodiments, the fluid is distributed in the form of drops by the nozzle along a first direction, and wherein the refrigerant fluid circulates in the circulation circuit of the condenser along a second direction opposite to the first direction.

According to these embodiments, the refrigerant fluid and the fluid distributed in the form of drops by the nozzle circulate in opposite directions, which increases efficiency of heat exchanges.

In one or more embodiments, the method further comprises:
collecting a part of the fluid distributed in the form of drops by the nozzle and circulating in a zone delimited by the membrane and comprising the nozzle;
cooling said part of the collected fluid down to the second temperature;
   wherein the part of the cooled fluid is used to at least partially supply the circulation circuit of the condenser.

According to these embodiments, the remaining part of the non-purified liquid distributed in the form of drops that has not passed through the membrane in the form of vapour is recovered to be cooled and reinjected as a refrigerant liquid.

Further, the method may comprise:
heating the refrigerant fluid at the outlet of the circulation circuit of the condenser up to the first temperature;
   wherein the refrigerant fluid heated is at least partially used as a fluid to be distributed in the form of drops by the nozzle.

In this case, the refrigerant liquid, after passing through the condenser, is heated to supply the nozzle.

These additional steps advantageously allow the implementation of a closed circuit, in which the fluid is reused, sometimes as a hot liquid supplying the nozzle, sometimes as a refrigerant liquid. As detailed hereinafter, the refrigerant liquid heats up as it passes through the condenser, while the non-evaporated part of the fluid distributed in the form of drops by the nozzle cools down between the moment it is distributed in the form of drops and the moment it is collected. Thus, the fluid to be heated has already been partially heated, which limits energy consumption required to heat the fluid exiting the condenser up to the first temperature. In other words, the condensation heat is advantageously used to limit energy requirements for operating the device.

### BRIEF DESCRIPTION OF THE FIGURES

Further characteristics and advantages of the invention will become apparent upon reading the description, which can be read in conjunction with the figures. These figures are set forth by way of indicating and in no way limiting purposes of the invention.

FIG. 1 represents an example of a device for purifying a fluid in the liquid phase, according to one embodiment of the invention.

### DETAILED DESCRIPTION

In the following, water is used as an example of a fluid to describe the phenomena, but it is understood that the invention applies to any fluid.

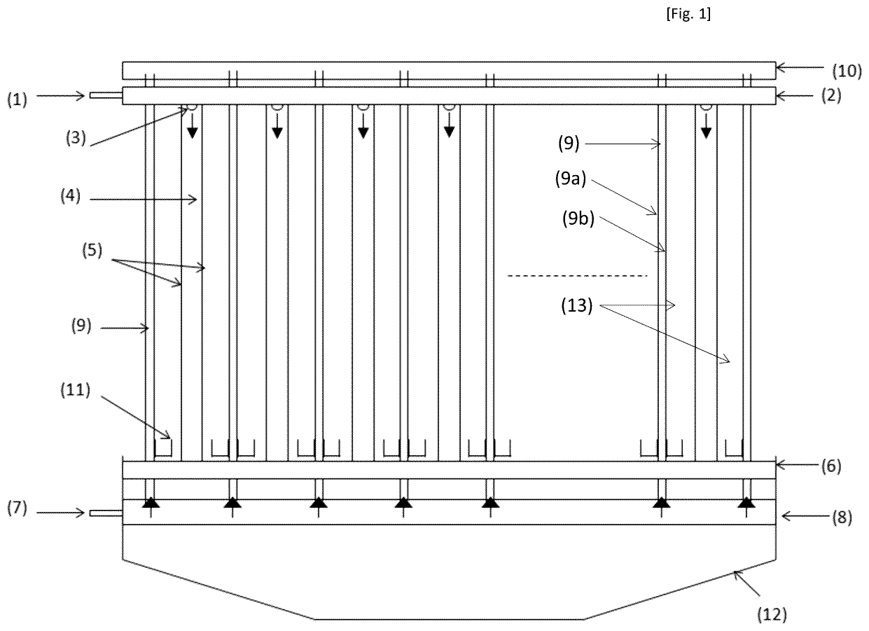

FIG. 1 represents an example of a device for purifying a fluid in the liquid phase, according to one embodiment of the invention.

The device in FIG. 1 comprises a plurality of semi-permeable membranes 5, i.e. permeable to the fluid in the gas phase but impermeable to the fluid in the liquid phase. More precisely, the membranes 5 are impermeable to the fluid in the liquid phase when it is, for example, projected against the membranes 5 in the form of drops, the aim being that, in the context of the invention, only gas particles of the liquid can pass through the membranes 5. The device also comprises a plurality of condensers (or cold traps) 9. By “condenser”, it is understood a device configured to condense (or liquefy) vapour. For example, each condenser may be a planar condenser comprising two walls 9a, 9b between which there is a circuit for circulation of a refrigerant fluid. The walls 9a, 9b of the condenser 9 are advantageously impermeable to fluids (in both the liquid and gas phases).

The membranes 5 do not allow the liquid distributed by the nozzles 3 to pass therethrough. For example, the membranes 5 may be impermeable to liquid drops. The membranes 5 may be, for example, membranes one or more of the following materials: Teflon or PTFE, Poly VinyliDiene Fluoride or PVDF, Poly Propylene or PP, and PolyEthylene or PE. The pore thickness of the membranes 5 may be determined by routine testing by a person skilled in the art, and especially pore sizes ranging from 60 micrometres to 60 nanometres may be used. In some embodiments, the membranes 5 may be comprised of a fabric coated with a treatment to make it impermeable.

The material used to make a wall of a condenser or cold trap may be a metal or a heat-conductive material. Stainless steel, for example, or a plastic, may be used, especially if the cold liquid circulating in the condenser is salt or corrosive water.

Referring again to FIG. 1, pairs of membranes 5 and condensers 9 are alternately disposed, so that exactly two membranes 5 are disposed between two condensers 9.

Two membranes 5 disposed between two consecutive condensers 9 delimit a space 4 having, vertically above, a nozzle 3 configured to distribute a fluid in the liquid phase in the form of drops or droplets. This space constitutes a “first fluidic channel” 4 in which the fluid distributed by the nozzle 3 circulates. By “fluidic channel”, it is understood a volume in which a fluid can flow or circulate, in the liquid or gas phase. A fluidic channel can advantageously be delimited by two separators (example membranes 5 and/or walls of the condenser 9), which maximises surface areas for heat exchange or material exchange, such as for vapour passing therethrough.

The space 13 between a condenser 9 and the membrane 3 closest to the condenser 9 is referred to as the “second fluidic channel” 13. Each second fluidic channel 13 may comprise a gutter 11 or any other means of recovering liquid formed by condensation on the condenser 9. The gutter 11 may be connected to a purified or pure water collector 12.

Thus, in FIG. 1, channel 4 and condenser 9 are separated by a small reservoir or gutter 11 for collecting water drops in the liquid form from the surface of the wall 9a, 9b of the condenser 9. The first channel 4, nozzle 3, gutter 11 and condenser 9 form a periodic pattern repeated in FIG. 1, between a hot water distributor 2 and a hot water collector 6 connected via the channel 4 containing the nozzle 3, and between a cold water distributor 8 and a cold water collector 10 connected via the condenser 9.

It appears from the following description that the invention can be implemented as long as the device comprises a nozzle 3, a membrane 5 and a condenser 9, with the membrane 5 being located between the nozzle 3 and the condenser 9. Thus, the invention is not limited to a plurality of nozzles 3, condensers 9 and membranes 5. When the device comprises a plurality of these elements, the volume of purified liquid collected is greater, since purified liquid can be collected in parallel in several channels, each bordered by a membrane 5 and a wall 9a, 9b of the condenser 9, for example via several gutters such as the gutter 11.

FIG. 1 thus shows a hot water supply 1 connected, in the fluidic sense, via a hot water distributor 2 to the nozzle 3 disposed internally to the membrane of the channel 4, as well as a hot water collector 6 extending from the channel 4.

FIG. 1 also shows a cold water supply 7 connected to the condenser 9 via a cold water distributor 8 which is connected, in the fluidic sense, to a cold water collector 10 via the condenser 9.

In FIG. 1, the membranes 5 and the walls 9a, 9b of the condensers 9 are vertical and parallel surfaces. It is understood that the degree of parallelism of these elements may, without departing from the teaching of the present application, be imperfect. In particular, it is especially important that a fluid in the vapour phase can reach a wall of the condenser 9 via the channel 4. Verticality of the membranes 5 and the walls 9a, 9b of the condensers 9 are therefore to be understood in the present application as a characteristic for maximising conversion of vapour into liquid between the interior of the membrane of the first channel 4 and the surface of the wall 9a, 9b of the condenser 9, while facilitating collection of condensate by the gutter and minimising the overall size of the entire device. From this point of view, the “vertical” characteristic, in the geometric sense, can be understood for the purposes of the present invention and in all its embodiments as forming an angle, for example, between 70° and 110°, relative to the ground.

According to the invention, a non-purified hot liquid (the liquid may be a mixture of, for example, water and minerals or water and salt or solutes) is introduced through a supply 1, and then distributed by a hot liquid distributor 2 to nozzles 3 which disperse it vertically in the form of drops inside the channels 4. For example, the non-purified hot liquid may be water from a stock of water, for example a sea or a lake or a stock of wastewater, possibly heated to a first, so-called, “hot” temperature.

A second liquid, referred to as a refrigerant liquid, which is colder than the hot liquid, is introduced through a supply 7 and then distributed by a cold liquid distributor 8, which distributes it to the condensers 9 disposed in parallel in FIG. 1.

by “hot liquid”, it is understood a liquid having a temperature higher than the maximum temperature of the refrigerant liquid circulating in the condenser 9. For example, the difference between the temperature of the hot liquid (when distributed in the form of drops by the nozzles 3) and the maximum temperature of the refrigerant liquid circulating in the condenser 9 may be greater than 30° C. For example, the hot liquid may be distributed in the form of drops at a temperature between 60° C. and 90° C., and the refrigerant liquid may have a temperature between 10° C. and 30° C. Of course, the preceding temperatures are provided by way of example, and other temperatures or temperature differences may be used.

After having been distributed in the form of drops by the nozzle 3, the non-purified, hot liquid flows through the channel 4, delimited by two membranes 5, and part of this non-purified, hot liquid passes through the membranes 5 in the form of purified fluid vapour. For example, if the non-purified, hot liquid is salt water, part of this liquid passes in the form of pure water vapour and passes through the membranes 5. Less purified liquid then remains in the channel 4 delimited by the two membranes 5 (i.e. more concentrated for at least one of its components, for example water with an even higher salt content, since some of the pure water has evaporated) and colder than at the outlet of the nozzle 3. This liquid, with more salt and less hot than at the nozzle outlet, can then be collected in a collector 6.

Indeed, the role of the membranes 5 or the membrane 5 is to prevent the liquid distributed in the form of drops in the channel 4 from passing partially or totally into the zone 13, which is delimited by a condenser 9 and a membrane 5. Only vapour from the liquid can pass therethrough, thus avoiding any contact between the hot liquid in the channel 4 and the vapour condensate formed in the zone 13 on the wall of the condenser 9. When a temperature difference is created between the two sides of the membrane 5, a partial vapour pressure difference appears, driving the process. This causes the liquid to evaporate from the surface of the liquid on the hot side, generating vapour that passes through the membrane 5 and condenses on the colder side where the condenser 9 is located.

The space between a condenser 9 and a membrane 5 forms a channel 13 in which the vapour from the hot liquid derived from the nozzle 3 and passed through the membrane 5 diffuses. The role of the condensers 9 is to condense this vapour on one of its walls 9a, 9b to form purified liquid. This purified liquid is colder than the vapour derived therefrom, while, conversely, the refrigerant liquid heats up on contact—via the wall 9a, 9b of the condenser 9—with the hotter vapour.

The refrigerant liquid can be collected at the outlet of the condenser 9 circulation circuit in a cold liquid collector 10, at a temperature higher than that it had at the inlet of the condenser 9 circulation circuit.

The condensate (purified water, example) slides along the wall of the condenser 9 and can be collected in the gutter 11 placed, for example, on the wall (several gutters in the height direction of the condenser 9 may also be provided). The condensate can then be transported sideways to be collected in a pure water reservoir or collector 12.

In alternative modes, the gutter or gutters 11 may either be assembled to the condensers by mechanical attachment of the material composing this gutter or these gutters, or be delimited by the external shape of the condenser or condensers by moulding, i.e. delimited by the wall of a condenser, i.e. by the shape of its external surface on which condensation is achieved.

It is noted that in the example of FIG. 1, the elements of the device are disposed in the following order, in a direction parallel to the membranes 5 and oriented from cold water collector 10 and refrigerant liquid distributor 8: the cold water collector 10, the hot water distributor 2, the hot water collector 6 and the refrigerant liquid distributor 8. Such an arrangement allows the liquids to circulate in the channel 4 and the refrigerant fluid circulation circuit in the condenser 9 in opposite or counter-current directions. Such counter-current circulation advantageously allows for a particularly efficient heat exchange between hot drops produced by the nozzle 3 and cold liquid via the membrane 5 and the walls 9a, 9b of the condenser 9.

Other configurations are possible, and according to one alternative embodiment of the invention, the elements of the device may be disposed in the following order, along the direction parallel to the membranes 5 and oriented from the cold water collector 10 and the refrigerant distributor 8: the cold water collector 10, the hot water collector 6, the hot water distributor 2 and the refrigerant distributor 8. In this case, circulation of liquids in the channel 4 and the refrigerant fluid circulation circuit in the condenser 9 is carried out in the same direction, and the invention is still operational, even if heat exchanges are less efficient than in embodiments where circulation of liquids is in the opposite direction.

As mentioned above, the invention can be implemented by means of a supply 1 of hot water or hot fluid at a first temperature, distributed in the form of drops by a nozzle 3 and creating a vapour of the (purified) fluid and drops of the fluid (even less pure than the hot fluid distributed by the nozzle 3), the vapour of the fluid passing through the membrane 5, which is permeable to the vapour and impermeable to the drops, to reach a wall 9a, 9b impermeable to the fluid, the wall 9a, 9b being supplied with a refrigerant fluid via a cold water supply 7, the refrigerant fluid being injected between the walls of the condenser 9 at a second temperature lower than the first temperature. Thus, it occurs condensation of the fluid into purified water drops on a surface of wall 9a, 9b, which is in contact with cold water or a purified cold fluid at a temperature lower than the first temperature.

Several embodiments for the hot and cold supplies are possible.

In a first embodiment, the hot fluid and the cold fluid are not reused and are both lost: there is then an open-circuit hot fluid supply and an open-circuit cold fluid supply, independent of the hot fluid supply. In other words, once the refrigerant liquid has passed through the condenser 9, it is purged out of the device. Likewise, the part of the hot liquid that has not evaporated (part of the liquid that arrives at the bottom of channel 4, which is less hot and more salty than the liquid distributed in the form of drops by the nozzle 3) is purged from the device, for example, discharged to a waste water circuit. New refrigerant fluid is injected into the condenser 9 via the cold water supply 7 and new hot liquid supplies the nozzle 3 via the hot liquid distributor 2.

In a second embodiment, the hot fluid is reused to be purified again. In other words, the part of the hot, salt liquid distributed in the form of drops by the nozzle 3 that has not passed through the membrane 5 in the form of vapour is collected at the bottom of the channel 4. As this remaining liquid has cooled during its passage through the channel 4, it is possible to heat it up to the first temperature using a heating system and then to reinject it into the hot liquid distributor 2, to be distributed in the form of drops by the nozzle 3. For example, the liquid collector 6 can be connected to the inlet of the heating system, for example via a connection pipe, and the heating system can be connected at its outlet to the hot liquid distributor 2, for example via a connection pipe. In this case, the hot fluid supply is said to be in a “closed circuit”, even if this term does not exclude the possibility of additional liquid being injected into the circuit via the hot water supply 1. In this embodiment, after a few passages through the device, the remaining liquid is highly salty, which requires it to be discarded after a number of cycles. Alternatively, it is possible to reinject less salty liquid (for example seawater heated to the first temperature) either after each passage or after a predefined number of passages through the device. Thus, in this embodiment, the hot liquid distributor 2 is advantageously connected, via the heating system, to a source of non-purified liquid, in order to regularly dilute the hot liquid distributed in the form of drops by the nozzles 3. In this second embodiment, the refrigerant can be discarded as in the first embodiment, or reused as in the third embodiment described hereinafter. However, in this embodiment, the hot fluid and refrigerant fluid supplies are independent.

In a third embodiment compatible with the second embodiment, the refrigerant fluid at the outlet of the condenser 9 is reinjected at an inlet thereof. In other words, the cold liquid collector 10 is connected to the cold liquid distributor 8 so that the refrigerant exiting the condenser 9 and arriving in the cold liquid collector 10 is reinjected at the inlet of the condenser 9 via the cold liquid distributor 8. When the refrigerant fluid circulates from the condenser inlet (connected to the cold liquid distributor 8) to the outlet of the condenser 9 (to reach the cold liquid collector 10), it heats up due to contact between the hot liquid vapour and the condenser walls 9a, 9b. Therefore, the refrigerant fluid at the outlet of the condenser 9 is advantageously cooled in a cooling system before being reinjected into the condenser 9. For example, the cold liquid collector 10 may be connected via a connection pipe to an inlet of the cooling system, and an outlet of the cooling system may be connected via another connection pipe to the cold liquid distributor. According to this embodiment, the refrigerant fluid supply is in a “closed circuit” (and there is no need to provide additional refrigerant fluid delivery, as it does not undergo any transformation or loss). In this third embodiment, the hot fluid can be discarded as in the first embodiment, or reused as in the second embodiment. However, in this third embodiment, the hot fluid and refrigerant fluid supplies are still independent.

In a fourth embodiment, the hot fluid and refrigerant fluid supplies are not independent: the remaining part of the hot liquid is cooled to the second temperature to be used as refrigerant liquid, and then heated at the outlet of the condenser 9 up to the first temperature to be distributed in the form of drops by the nozzles 3, and so on. It is noted that at the outlet of the condenser 9, the cooling liquid has been heated, which reduces the amount of energy required to bring it to the first temperature. Hence, at the outlet of channel 4, the remaining part of hot fluid has been cooled, which also reduces the amount of energy required to bring it to the second temperature. To implement this fourth embodiment, it is possible, for example, to connect the hot liquid collector 6 to the inlet of the cooling system and to connect the outlet of the cooling system to the cold liquid distributor 8 to supply the condenser 9. The cold liquid collector 10 can be connected to the inlet of the heating system, and the outlet of the heating system can be connected to the hot liquid distributor 2 to be distributed in the form of drops by the nozzles 3. In this fourth embodiment, there is a single closed-loop fluid supply, through which the hot fluid and then the same (possibly saltier) cooled fluid travel. Here again, even if the term “closed loop” does not exclude the possibility of additional liquid being injected into the fluid circulation circuit. Indeed, after several passages through the device, the remaining liquid may be highly salty, and it is possible to reinject, either regularly or when it is detected that the salt concentration of the circulating liquid exceeds a threshold value, less salty liquid (example: seawater) into the fluid circulation circuit. For example, the cooling system and/or the heating system may comprise an inlet for receiving less salty liquid. Alternatively, the less salty liquid can be added upstream of the cooling system or the heating system. Thus, in this fourth embodiment, the liquid circulation circuit can be advantageously connected to a source of non-purified liquid, in order to regularly dilute the circulating liquid supplying both the condensers 9 and the nozzles 3.

This fourth embodiment makes it possible to improve thermodynamic efficiency of the liquid purification method: indeed, latent heat exchange takes place between vapour of the fluid used and drops of this fluid distributed in the form of recycled drops in an undivided liquid phase, in contact with the wall. This characteristic improves condensation and simultaneously heats up the recycled liquid, reducing power required to heat this liquid to the distribution temperature via the nozzle 3. A 50% saving in heating power can thus be observed relative to other embodiments, although this number may vary as a function of the dimensions.

In this fourth embodiment, It is possible to use a single pump to draw in the liquid from the distributed drops in the form of heated drops and the liquid from a hot water source to perform the initial hot water supply to the nozzle of the closed fluidic circuit above and obtain a purified water or purified liquid fluid generator by means of the device of the present application. In other words, in this embodiment, the device comprises an initial hot water supply, distributed in the form of drops by a nozzle and separated by a membrane permeable to water vapour, impermeable to the water drops distributed in the form of drops and non-absorbent to water, a condenser impermeable to fluids, in contact with cold water on one side and on the other side with the water vapour collected after condensation, in purified water drops resulting from the condensation of the water vapour transported between the nozzle and the condenser via the membrane. The purified liquid can be collected by virtue of one or more gutters placed on the surface of the condenser.

With reference to FIG. 1, it is possible to establish a first fluidic connection between the hot water collector 6 and the cold water supply 7, and then establish a second fluidic connection between the cold water collector 10 and the hot water supply 1 of the nozzle 3 to make the closed fluidic circuit of the fourth embodiment. In addition, a cooling means, especially via a heat exchanger, can be inserted onto the first connection. Finally, a heating means such as a heat exchanger with a heat source can be inserted onto the second connection, and a pump can also be inserted in series onto this second connection to achieve a complete device for producing purified fluid, especially purified water.

In all embodiments, the heating system may comprise, for example, an electrical resistor or may be a system for bringing the fluid into thermal contact with a heat source, i.e. at a higher temperature than the fluid. Particularly advantageously, the heating system may use free heat from an industrial method.

The cooling system may be a system for bringing the fluid into thermal contact with a cold source, i.e. at a lower temperature than the fluid.

In one or more embodiments, a liquid may be compressed after being distributed in the form of drops by a nozzle by collecting or pooling the liquid in a “divided” form “(i.e. in the form of drops) present at the outlet of the channel 4 to restore it to a “non-divided” liquid form (i.e. in the form of pooled liquid and not in the form of drops), and then sucking up this liquid with a pump and compressing the liquid form by means of the pump.

Dimensioning the characteristics of the device according to one embodiment, designed to obtain 30 tonnes of purified water condensate per day in a seawater-based facility, is detailed hereinafter by way of example.

A stock of cold, salty seawater, for example withdrawn from the ocean, can be used as a cold source and as a means of dilution, as well as a heat source, for example obtained by solar heating or by recovering lost energy in an engine.

Cold, salty seawater can be introduced into a closed fluidic circuit and circulated by means of a pump.

In this closed fluidic circuit, the seawater can be pre-heated by the condensing water vapour as it passes through the condenser 9, in a direction opposite to that of the hot drops (counter-current configuration), and then heated by the heat source by means of a first separate-fluid exchanger. It can then pass through a nozzle soaked in an atmosphere, and then be distributed in the form of drops (example, sprayed) into the atmosphere, losing water vapour, to be collected in a concentrated salt form in a reservoir. The salt-concentrated water can be pumped from the reservoir, and then cooled by the stock of cold seawater in a second separate-fluid exchanger, and finally diluted by water from the stock of cold seawater in a mixer. In the atmosphere, a membrane 5 that is permeable to water vapour and impermeable to liquid water can separate the nozzle 3 and the condenser 9, allowing separate-fluid condensation between the liquid emitted by the nozzle 3 and the condensate. The condensate and the liquid circulating in the condenser 9, made of a fluid-impermeable material, are separated by the material of the condenser 9.

In this way, a closed seawater circuit is obtained which is able to produce, on the external wall of the condenser, a condensate of the water vapour withdrawn from the drops and having migrated via the membrane. Thus purified water without contact with seawater, neither in its form distributed by the nozzle, nor in its form transported inside the condenser, nor in the form contained in the stock of hot water is obtained.

As material is withdrawn in the form of water vapour from the circuit, the mixer makes it possible to dilute the seawater, concentrated by evaporation, with seawater from the stock of cold water. The seawater in the stock plays a primary role herein as a material tank, i.e. a tank of seawater with a constant salt concentration. The mixer can be connected to the circuit intermittently or continuously, as a function of a desired salinity range for the seawater circulating in the closed circuit.

In addition, advantageously the stock of seawater can also serve to further cool water concentrated by evaporation exiting the hot water collector, bringing it to a temperature close to that of stock of salt cold seawater, and herein playing a second, thermal tank, role.

The resulting device is particularly favourable for heat and condensation recovery. Tests were conducted on such a device with two condenser and membrane heights (the condensers and membranes having the same heights): 3 m for the first test and 2 m for the second test. These dimensions allow a heat expenditure of 300 (first case) to 450 (second case) kWh per m³ to be achieved. These numbers can be compared to the heat expenditure for a device without this heat recovery, which is in the order of 700 kWh per m³ of condensate. This represents an energy gain of 57% in the first test and 35% in the second test.

Given this energy performance, it will be possible to obtain 30 tonnes of purified water per day with a flow rate of 6.55 kg/s in the nozzle, an inlet flow rate of the mixer divided into 5.51 kg/s for the water collected via the drops emitted by the nozzle and 1.04 kg/s for water withdrawn from the stock of cold seawater.

The cold seawater flow rate for additional cooling by sensible heat loss can be adjusted to achieve a temperature 3 K higher than the temperature of the cold stock in order to achieve a temperature 2.5 K higher than the temperature of the stock of cold seawater at the mixer outlet and nozzle inlet. Likewise, the temperature of the hot source can be 58 K higher than that of the stock of cold water, in steady-state purified water production.

For these performance levels, the temperature of the stock of cold seawater can be especially 305 K and the temperature of the stock of hot seawater be 363 K.

A person skilled in the art will be able, by simple routine tests, to adapt the dimensions of the above embodiment to obtain different purified water productions or different energy yields as a function of the heat recovered or derived from available solar energy and the climate, without departing from the teaching of the present application.

The present application extends its teaching to a solvent containing a solute to obtain purified (or pure) or ultra-purified (or ultra-pure) solvent.

In all embodiments of the present application, the membrane and the condenser wall must not be in mechanical contact, which guarantees optimum purity of the purified fluid. However, if points of contact between the membrane and the wall exist, the device and method according to the invention operate in a degraded manner. For example, the purification of water initially containing 500 micro Siemens/cm of minerals results, without mechanical contact, in purified water with a conductivity of less than 9 micro Siemens/cm, whereas the presence of contact points leads to purified water with a conductivity in the order of 50 micro Siemens/cm.

1. A device for purifying a fluid in the liquid phase, comprising:
a nozzle for distributing said fluid in the form of drops into an atmosphere;
a wall of a condenser; and
a membrane permeable to said fluid in the gas phase and impermeable to said fluid distributed in the form of drops in the atmosphere, the membrane being disposed between the nozzle and the wall of the condenser;
wherein the wall of the condenser and the membrane delimit a first space, the membrane separates the first space from a second space comprising the nozzle, and wherein the condenser comprises a refrigerant fluid circulation circuit, the wall of the condenser separating the refrigerant fluid circulation circuit and said first space, the wall of the condenser being impermeable to the fluid in the liquid phase and in the gas phase and being configured to condense the fluid in the gas phase that passed through the membrane into a liquid phase of purified fluid.

2. The device according to claim 1, wherein the membrane comprises a first face oriented to the first space and a second face oriented to the second space, wherein the membrane is configured to operate at equal pressure on its first face and on its second face.

3. The device according to claim 2, wherein said pressure is atmospheric pressure.

4. The device according to claim 1, wherein the membrane and the wall of the condenser extend in substantially vertical planes.

5. The device according to claim 1, further comprising a first fluid distributor for supplying the nozzle with said fluid in the liquid phase and a second fluid distributor for supplying the refrigerant fluid circulation circuit with the refrigerant fluid.

6. The device according to claim 5, comprising a collector configured to collect at least one part of the fluid distributed by the nozzle in the form of drops and circulating in the second space.

7. The device according to claim 1, claims, wherein the refrigerant fluid circulation circuit, the nozzle and the second space belong to a same fluidic circuit.

8. The device according to claim 7, further comprising a first fluid distributor for supplying the nozzle with said fluid in the liquid phase and a second fluid distributor for supplying the refrigerant fluid circulation circuit with the refrigerant fluid, wherein the refrigerant fluid circulation circuit comprises an inlet and an outlet, the device further comprising a first connection circuit between the outlet of the refrigerant fluid circulation circuit and the first fluid distributor.

9. The device according to claim 8, wherein the first connection circuit comprises a heating system configured to heat a fluid circulating in said first connection circuit, a connection pipe connecting the outlet of the refrigerant fluid circulation circuit to said heating system, and a connection pipe connecting said heating system to the first fluid distributor.

10. The device according to claim 9, comprising a collector configured to collect at least one part of the fluid distributed by the nozzle in the form of drops and circulating in the second space, wherein the collector is connected to the second fluid distributor.

11. The device according to claim 10, wherein the collector is connected to the second fluid distributor by a second connection circuit, the second connection circuit comprising a cooling system configured to cool a fluid circulating in said second connection circuit, a connection pipe connecting the cooling system to the inlet of the refrigerant circulation circuit and a connection pipe connecting said cooling system to the collector.

12. The device according to claim 7, wherein the refrigerant fluid circulation circuit, the nozzle and the second space belong to a same closed fluidic circuit.

13. The device according to claim 1, wherein the refrigerant fluid circulation circuit and the second space belong to two independent fluidic circuits.

14. The device according to claim 1, further comprising a gutter to collect condensate formed on the wall of the condenser.

15. A method for purifying a fluid in the liquid phase using a device according to claim 1, comprising:
distributing, through the nozzle the fluid in the form of drops, the fluid distributed in the form of drops being at a first temperature;
supplying the circulation circuit of the condenser with the refrigerant fluid at a second temperature, the second temperature being strictly lower than the first temperature; and
collecting purified fluid in the liquid phase resulting from condensation of purified fluid in the gas phase along the wall of the condenser, said purified fluid in the gas phase being derived from passage of a gas part of the fluid distributed in the form of drops through the membrane.

16. The method according to claim 15, wherein the fluid distributed in the form of drops is salt-laden water, and wherein the purified fluid in the liquid phase is pure water.

17. The method according to claim 15, wherein the fluid is distributed in the form of drops by the nozzle along a first direction, and wherein the refrigerant fluid circulates in the circulation circuit of the condenser along a second direction opposite to the first direction.

18. The method according to claim 15, further comprising:
collecting a part of the fluid distributed by the nozzle in the form of drops and circulating in a zone delimited by the membrane and comprising the nozzle;
cooling said part of the fluid collected down to the second temperature;
wherein the part of the cooled fluid is used to at least partially supply the circulation circuit of the condenser.

19. The method according to claim 18, further comprising:
heating the refrigerant fluid at the outlet of the circulation circuit of the condenser to the first temperature;
wherein the refrigerant fluid heated is at least partially used as the fluid to be distributed in the form of drops by the nozzle.
